(19) United States
(12) Patent Application Publication
(10) Pub. No.: US 2007/0173152 A1
(43) Pub. Date: Jul. 26, 2007

(54) SYNTHETIC SLAB AND METHOD FOR MAKING THE SAME

(76) Inventor: Yin-Chih Chen, Feng Yuan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/307,233

(22) Filed: Jan. 27, 2006

(51) Int. Cl. B32B 27/04; B32B 27/12

(52) U.S. Cl. 442/149; 442/286

(57) ABSTRACT

A method is disclosed for making a synthetic slab. The method includes the steps of providing coconut shells, shredding the coconut shells into shreds, drawing fibers from the shreds, making a substrate of the fibers, forming a synthetic slab by means of at least coating the substrate with an adhesive and shaping the synthetic slab.

### BACKGROUND OF INVENTION

1. Field of Invention

The present invention relates to a synthetic slab and a method for making the same.

2. Related Prior Art

Plywood is often used in interior decoration and furniture. To make the plywood, left-over strips are collected from lumber mills. The left-over strips are glued to one another so as to form a laminate. The laminate is compressed into plywood. The plywood generally includes three layers. The fibers of the superficial layers extend substantially perpendicular to that of the intermediate layer. The plywood provides a barely satisfactory strength and is vulnerable to humidity and fire. The production of the plywood is however based on the operation of the lumber mills. If the operation of the lumber mills is reduced for protecting the environment, the production of the plywood will surely be reduced too.

The present invention is therefore intended to obviate or at least alleviate the problems encountered in prior art.

### SUMMARY OF INVENTION

According to the present invention, a method is disclosed for making a synthetic slab. The method includes the steps of providing coconut shells, shredding the coconut shells into shreds, drawing fibers from the shreds, making a substrate of the fibers, forming a synthetic slab by means of at least coating the substrate with an adhesive and shaping the synthetic slab.

The primary advantage of the method of the present invention is its friendliness to the environment. On one hand, it solves the problem of disposing of the coconut shells by means of recycling them. On the other hand, it saves trees that are often cut and used as lumbers or as a raw material for plywood.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a flowchart of a method for making a synthetic slab according to the preferred embodiment of the present invention.

FIG. 2 shows two phases of a coconut.

FIG. 3 is a cross-sectional view of a shredding machine for shredding the coconut shown in FIG. 1.

FIG. 4 is a perspective view of a substrate made of fibers of the shredded coconut shown in FIG. 3.

FIG. 5 is a rolling machine for rolling the substrate shown in FIG. 4.

FIG. 6 is reduced perspective view of a synthetic slab made of the substrate shown in FIG. 4.

FIG. 7 is a cross-sectional view of a heating and pressing machine for heating and pressing the synthetic slab shown in FIG. 6.

FIG. 8 is an enlarged perspective view of the synthetic slab shown in FIG. 6.

### DETAILED DESCRIPTION OF PREFERRED EMBODIMENT

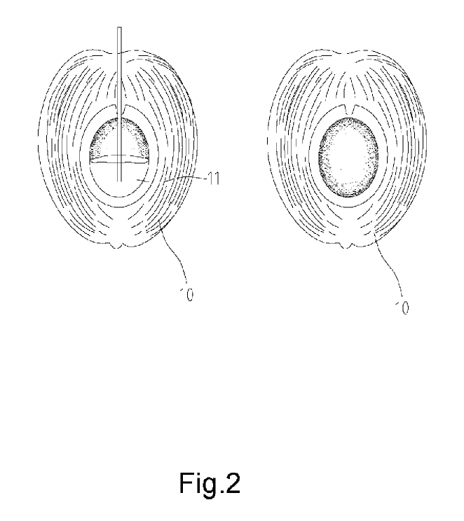

Referring to FIG. 2, there is shown a coconut. A coconut includes a shell 10, coconut meat grown on the internal side of the shell 10 and coconut milk 11 contained in the shell 10. The coconut milk 11 can be drunk. The coconut meat can be eaten. Traditionally, the shell 10 is disposed of. This is a shameful waste since the shell 10 includes a large number of fibers that are tougher and less vulnerable to fire than left-over strips of wood.

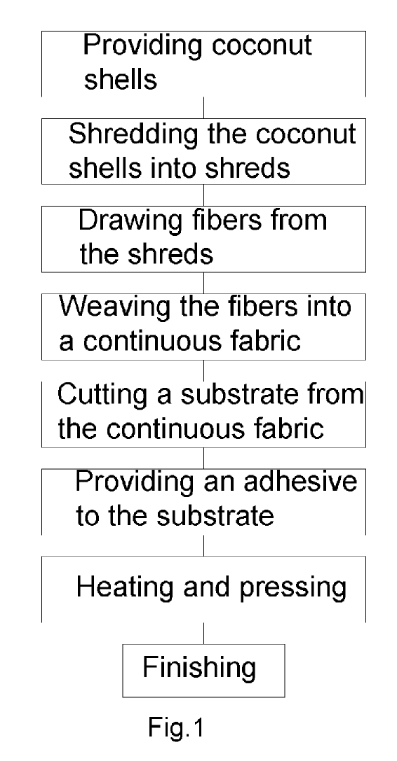

Now, coconut shells as the shell 10 shown in FIG. 2 can be used as raw material for a synthetic slab in a method according to the preferred embodiment of the present invention as shown in FIG. 1.

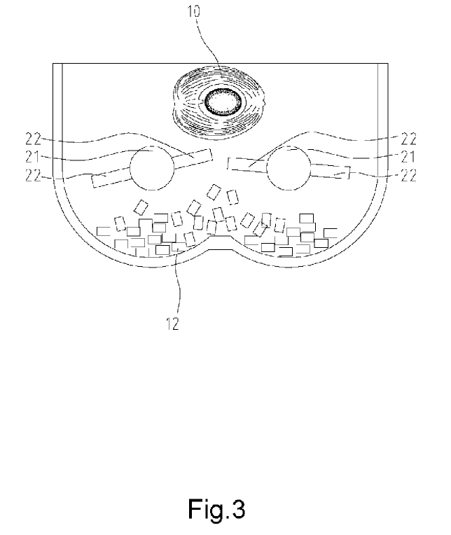

Referring to FIGS. 1 and 3, the coconut shells are shredded by means of a shredding machine 20. The shredding machine includes two shafts 21 and a plurality of blades 22 installed on the shafts 21. The coconut shells are shredded into shreds 12 by means of the blades 22 driven by means of the shafts 21.

Fibers are drawn from the shreds 12 of the coconut shells.

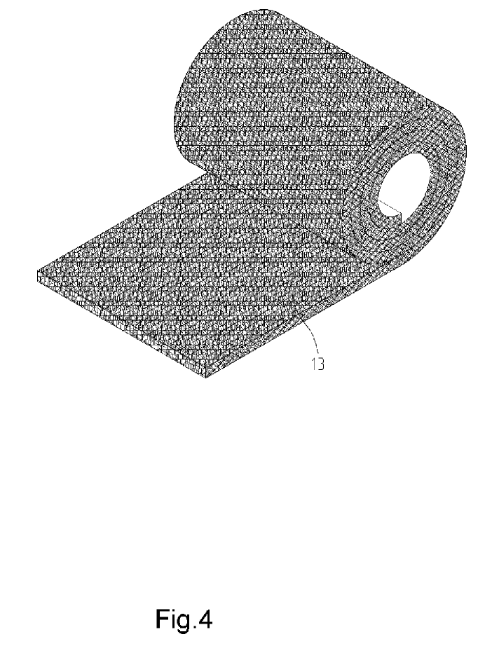

Referring to FIGS. 1 and 4, a substrate 13 is made of the fibers. The substrate 13 may be a woven fabric or a non-woven fabric. However, a woven fabric is preferred because it provides a better excellent strength than a non-woven fabric. The substrate 13 is tough yet flexile. Hence, the substrate 13 can be rolled for the convenience of storage.

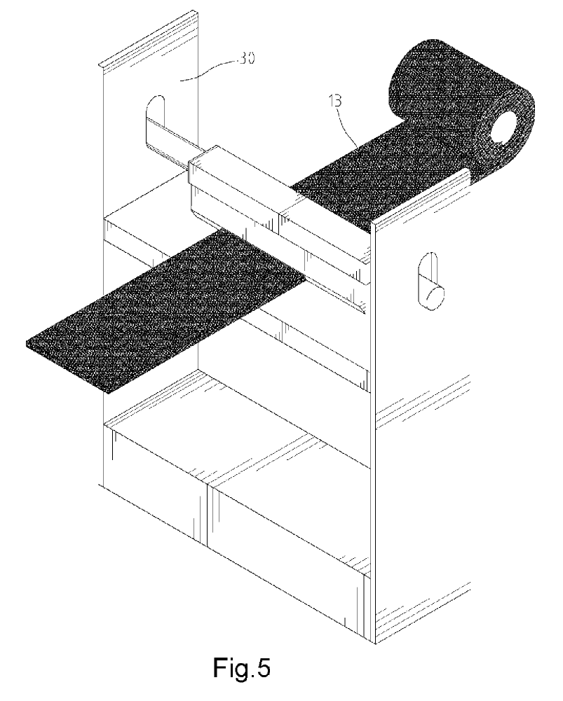

Referring to FIGS. 1 and 5, by means of a cutting machine 30, the substrate 13 is cut into pieces of desired lengths.

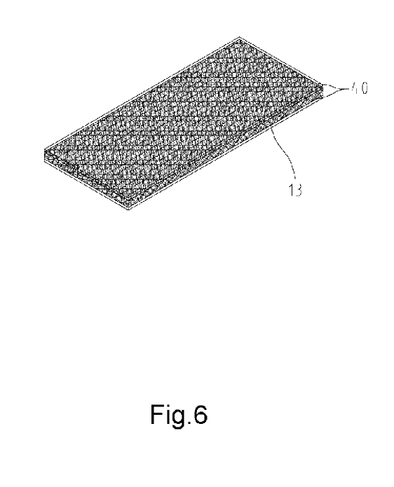

Referring to FIGS. 1 and 6, the substrate 13 is coated with an adhesive 40. Alternatively, the substrate 13 may be submerged in the adhesive 40 so that the adhesive 40 penetrates the substrate 13.

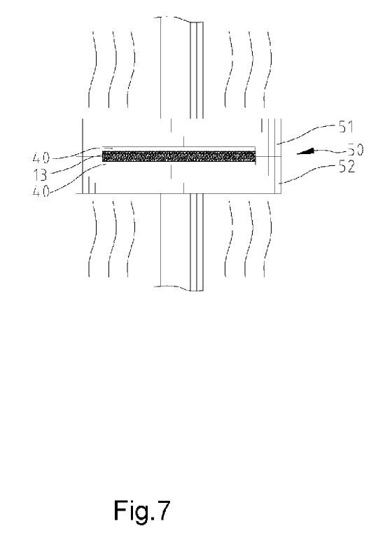

Referring to FIGS. 1 and 7, the adhesive 40 and the substrate 13 are heated and pressed by means of a heating and pressing machine 50. The heating and pressing machine 50 includes two heating and pressing mold parts 51 and 52. The adhesive 40 and the substrate 13 are located between the heating and pressing mold parts 51 and 52 so that the former can be heated and pressed by means of the latter. Thus, the adhesive 40 cures and the substrate 13 becomes dense. The adhesive 40 and the substrate 13 form a synthetic slab. Thus, the shape of the synthetic slab is molded and retained.

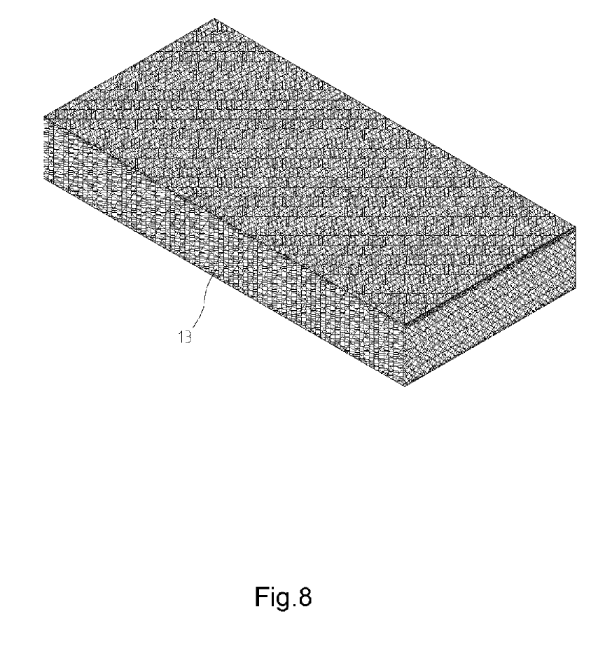

Referring to FIGS. 1 and 8, the synthetic slab is furnished. For example, the synthetic slab is polished so that it includes a smooth surface, and is painted with desired colors and patterns. Hence, a final product of the synthetic slab is made.

According to the preferred embodiment of the present invention, the synthetic slab includes the substrate 13 and the adhesive 40. The substrate 13 is preferably a fabric woven of the fibers drawn from the coconut shells. The fibers drawn from the coconut shells are tough and not vulnerable to fire. The substrate 13 is dense and tough and not vulnerable to fire. The adhesive 40, when cured, retains the shape of the substrate 13 and protects the substrate 13 from humidity.

The method for making the slab according to the present invention exhibits at least one advantage. That is, it is environment friendly. On one hand, it solves the problem of disposing of the coconut shells by means of recycling them. On the other hand, it saves trees that are often cut and used as lumbers or as a raw material for plywood.

The synthetic slab according to the present invention exhibits several advantages. Firstly, it is dense. Secondly, it is tough. Thirdly, it is not vulnerable to fire. Fourthly, it is not vulnerable to humidity.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A synthetic slab comprising:
a substrate made of fibers drawn from coconut shells; and
an adhesive at least coated on the substrate so that the synthetic slab is dense, tough and not vulnerable to fire and humidity.

2. The synthetic slab according to claim 1 wherein the substrate is a fabric.

3. The synthetic slab according to claim 2 wherein the fabric is a woven fabric.

4. The synthetic slab according to claim 1 wherein the adhesive penetrates the substrate.

5. A method for making a synthetic slab comprising the steps of:
providing coconut shells;
shredding the coconut shells into shreds;
drawing fibers from the shreds;
making a substrate of the fibers;
forming a synthetic slab by means of at least coating the substrate with an adhesive; and
shaping the synthetic slab.

6. The method according to claim 5 wherein the step of shredding the coconut shells comprises the step of providing a shredding machine.

7. The method according to claim 6 wherein the shredding machine comprises at least one shaft and a plurality of blades installed on the shaft.

8. The method according to claim 5 wherein the step of making the substrate comprises the step of weaving the fibers.

9. The method according to claim 5 wherein the step of making the substrate comprises the steps of:
making a continuous fabric of the fibers so that the continuous fabric can be rolled; and
cutting the substrate of a desired length from the continuous fabric.

10. The method according to claim 5 wherein the step of forming the synthetic slab comprises the step of submerging the substrate in the adhesive so that the adhesive penetrates the substrate.

11. The method according to claim 5 wherein the step of shaping the synthetic slab comprises the step of heating and pressing the synthetic slab.

12. The method according to claim 11 wherein the step of heating and pressing the synthetic slab comprises the step of providing a heating and pressing machine for heating and pressing the synthetic slab.

13. The method according to claim 12 wherein the heating and pressing machine comprises two heating and pressing mold parts.

14. The method according to claim 5 comprising the step of finishing the synthetic slab after the step of shaping the synthetic slab.

15. The method according to claim 5 comprising the step of painting the synthetic slab after the step of finishing the synthetic slab.
